(19) United States
(12) Patent Application Publication
(10) Pub. No.: US 2012/0326626 A1
(43) Pub. Date: Dec. 27, 2012

(54) LED CONTROL SYSTEM

(75) Inventors: CHUN-SHENG CHEN, Tu-Cheng (TW); FENG-LONG HE, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD., Shenzhen City (CN)

(21) Appl. No.: 13/197,789

(22) Filed: Aug. 4, 2011

(30) Foreign Application Priority Data
Jun. 24, 2011 (CN) 201110172828.1

(51) Int. Cl. H05B 37/02

(52) U.S. Cl. 315/294; 315/291

(57) ABSTRACT

An LED control system includes a platform controller unit, a peripheral interface control chip connecting with the platform controller unit, and an LED unit connecting with the peripheral interface control chip. The platform controller unit outputs control instructions to the peripheral interface control chip. The control instructions outputted by the platform controller unit is transformed via programming the peripheral interface control chip, so that the on/off state of the LED unit as well as brightness and color of light emitted from the LED unit can be controlled by pulse signals output from the output ports of the peripheral interface control chip.

### BACKGROUND

1. Technical Field

The present disclosure relates to light emitting diode (LED) control systems, and particularly to an LED control system with high working efficiency.

2. Description of Related Art

Referring to FIG. 2, a conventional LED control system includes a platform controller hub (PCH), a microcontroller (MCU) connecting with the PCH, an LED driver connecting with the MCU, and an RGB LED connecting with the LED driver. The RGB LED includes three encapsulated LEDs respectively emitting red, green and blue light. The light with different colors emitted from the LEDs mixes to form a light with a desired color. The PCH outputs control signals to the MCU and then to the LED driver, so that brightness and color of the light emitted from the RGB LED can be controlled. However, before the control signals outputted by the PCH reach the RGB LED, the control signals must be transformed and transferred by the MCU and the LED driver in sequence. As a result, the working efficiency of the conventional LED control system is very low.

What is needed, therefore, is an LED control system which can overcome the limitations described.

### BRIEF DESCRIPTION OF THE DRAWINGS

FIG. 1 is a schematic view of a circuit of an LED control system according to an exemplary embodiment of the present invention.

FIG. 2 is a schematic view of a circuit of a conventional LED control system.

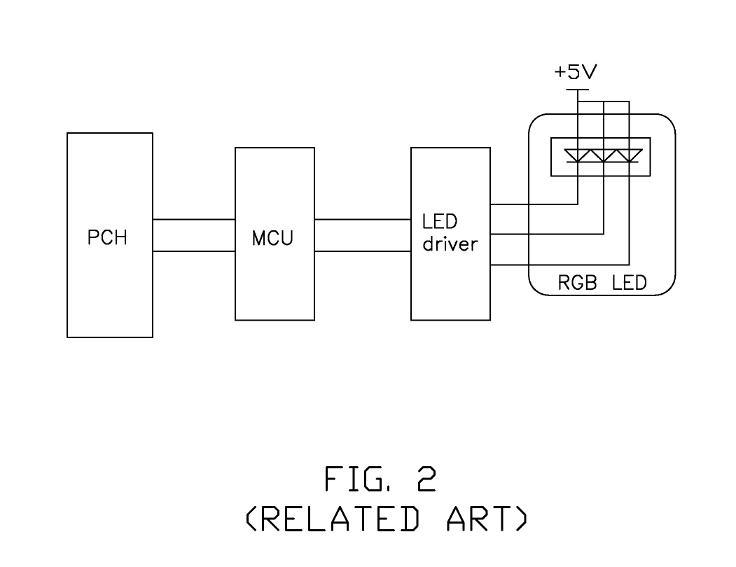

### DETAILED DESCRIPTION

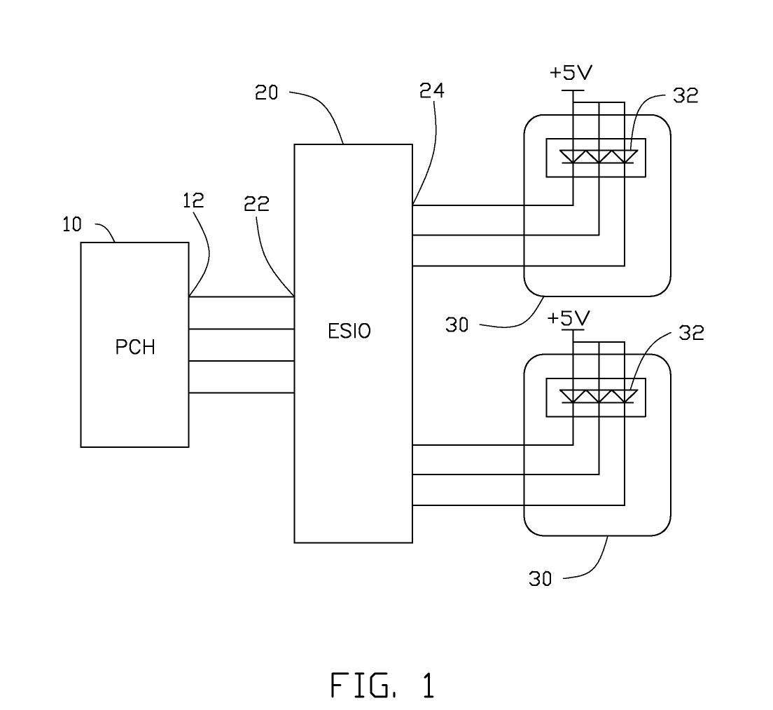

Referring to FIG. 1, an LED control system according to an exemplary embodiment of the disclosure can be used in LED lamps. The LED control system includes a platform controller unit 10, a peripheral interface control chip 20, and two LED units 30.

The platform controller unit 10 uses a chip of Platform Controller Hub (PCH) produced by Intel Corporation. The platform controller unit 10 connects with the peripheral interface control chip 20 and outputs control instructions to the peripheral interface control chip 20. The platform controller unit 10 includes four output ports 12.

Each LED unit 30 includes three LEDs 32 encapsulated therein. The three LEDs 32 respectively emit red, green and blue light. The light with different brightness and colors emitted from the LEDs 32 can be mixed in the LED unit 30 to form a light with predetermined brightness and color. The anode of each LED 32 connects a current voltage source with 5 volts for providing electric energy for the LED unit 30.

The peripheral interface control chip 20 uses a chip of ESIO IT8731 produced by ITE Corporation. The peripheral interface control chip 20 includes four input ports 22 and six output ports 24. The four input ports 22 of the peripheral interface control chip 20 connect with the four output ports 12 of the platform controller unit 10. The cathode of each LED 32 connects with one of the output ports 24 of the peripheral interface control chip 20. The control instructions outputted by the platform controller unit 10 are transformed via programming the peripheral interface control chip 20, so that the on/off states of the LEDs 32 of the LED units 30 as well as brightness and colors of light emitted from the LEDs 32 of the LED units 30 can be controlled by pulse signals with different duty cycles output from the output ports 24 of the peripheral interface control chip 20.

According to the disclosure, the LED control system of the present invention uses the peripheral interface control chip 20 to replace the microcontroller and the LED driver of the conventional LED control system, so the LED control system of the present invention has a higher working efficiency and a lower cost in comparison with the conventional LED control system.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED control system comprising:
a platform controller unit;
a peripheral interface control chip connecting with the platform controller unit, the platform controller unit outputting control instructions to the peripheral interface control chip; and
an LED unit connecting with the peripheral interface control chip;
wherein the control instructions outputted by the platform controller unit are transformed via programming the peripheral interface control chip, so that the on/off state of the LED unit as well as brightness and color of light emitted from the LED unit can be controlled by pulse signals output from the peripheral interface control chip.

2. The LED control system of claim 1, wherein the LED unit comprises three LEDs respectively emitting red, green and blue light, the red, green and blue light being mixed in the LED unit to form a light with predetermined brightness and color.

3. The LED control system of claim 2, wherein the peripheral interface control chip comprises three output ports, each of the LEDs of the LED unit connecting with one of the output ports of the peripheral interface control chip, the output ports of the peripheral interface control chip outputting pulse signals with different duty cycles to control the on/off states of the LEDs of the LED unit as well as brightness and colors of light emitted from the LEDs of the LED unit.

4. The LED control system of claim 3, further comprising a current voltage source, each of the LEDs comprising an anode and a cathode, the anode of each LED connecting with the current voltage source, the cathode of each LED connecting with one of the output ports of the peripheral interface control chip.

5. The LED control system of claim 3, wherein the peripheral interface control chip comprises four input ports, the platform controller unit comprises four output ports connecting with the four input ports of the peripheral interface control chip for outputting the control instructions to the peripheral interface control chip.
